(19) United States
(12) Patent Application Publication
(10) Pub. No.: US 2013/0063032 A1
(43) Pub. Date: Mar. 14, 2013

(54) INDUCTION LAMP CONNECTED LIGHT NODE

(71) Applicants: Michael Olen Nevins, Jackson, MI (US); Justin Baldwin, Jackson, MI (US)

(72) Inventors: Michael Olen Nevins, Jackson, MI (US); Justin Baldwin, Jackson, MI (US)

(73) Assignee: FULL SPECTRUM SOLUTIONS, Jackson, MI (US)

(21) Appl. No.: 13/612,254

(22) Filed: Sep. 12, 2012

Related U.S. Application Data
(60) Provisional application No. 61/533,540, filed on Sep. 12, 2011.

(51) Int. Cl. H01J 61/52; H05B 41/38

(52) U.S. Cl. 315/115

(57) ABSTRACT

A ballast system regulates the supply of power to an illuminant. The ballast system has a controller coupled to a power converter. The controller has a processor and a memory communicatively coupled with a bus. The memory comprising a lighting control system, and the processor is configured to execute the lighting control system to cause the power converter to increase or decrease power supplied to an illuminant.

### BACKGROUND

Induction fluorescent lamps offer the potential for increased life, lumen maintenance and efficacy for lighting applications.

Many lighting applications employing an induction fluorescent lamp function statically and do not account for changing environments, operating conditions, and/or usage requirements. Further, induction lamps decline in luminescence due to increased aging and usage of phosphor. Lumen output of electrodeless fluorescent lamps also changes due to changes in ambient air temperature. As such, the environment, operating conditions, and other usage requirements of an induction lamp impacts the effective luminescence of the lamp.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a side view of a street lamp having a cobra head light fixture according to an embodiment;

FIG. 2 is a high-level functional block diagram of a lighting device connected to a a mains power source;

FIG. 3a is a high-level functional block diagram of a controller;

FIG. 3b is a side view of a peltier device incorporated into the lighting device 100 to heat or cool an amalgam pellet;

FIG. 4. is a high-level functional block diagram of a lighting device connected to a mains power source;

FIG. 5 is a high-level function block diagram of a ballast.

FIG. 6 is a flow chart of a method of heating and/or cooling an amalgam pellet in accordance with an embodiment; and

FIG. 7 is a flow chart of a method of increasing or decreasing power to the illuminant in accordance with an embodiment.

### DETAILED DESCRIPTION

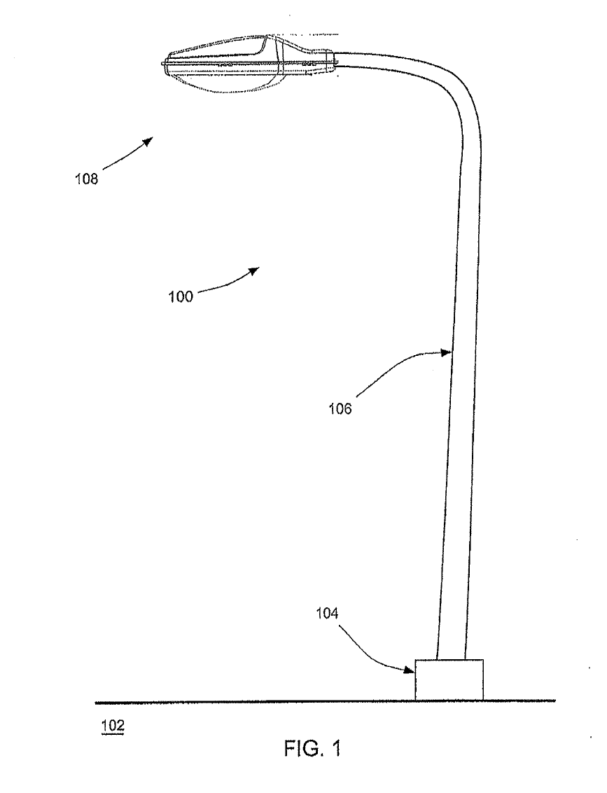

FIG. 1 depicts a perspective view of a lighting device 100 according to an embodiment of the present invention. Lighting device 100 is installed on a surface 102 by way of a pedestal 104. In at least some embodiments, surface 102 comprises ground, roadway, or other supporting surface. In at least some embodiments, pedestal 104 comprises any of a number of supportive materials such as stone, concrete, metal, etc. In other embodiments, lighting device 100 is suspended from an elevated surface, such as a ceiling, roof, beam or other elevated structure. In still further embodiments, lighting device 100 is attached to a vertical or angled vertical surface, such as a wall.

In at least one embodiment, lighting device 100 comprises a vertical support 106. In at least some embodiments, support 106 may extend horizontally or at a different angle in-between horizontal and vertical. In at least some embodiments, support 106 is hollow; however, in other embodiments different configurations may be possible. In at least some embodiments, support 106 may be comprised of metal, plastic, concrete and/or a composite material.

In at least some embodiments, support 106 also provides a conduit through which electricity is supplied to the light fixture. For example, a connection to a mains or other power source may be provided.

Lighting device 100 comprises a light fixture 108. In at least one embodiment, light fixture 108 is a cobra head light fixture physically connected to support 106. Light fixture 108 comprises an induction-based light source for providing illumination to an area adjacent support pole 106. In other embodiments, light fixture 108 is a high bay fixture, low bay fixture, shoebox fixture, garage fixture, wall pack fixture, canopy fixture, barn fixture, walkway fixture, or other similar fixture.

Light fixture 108 is an induction-based light source in order to provide increased lifespan and/or reduce a required initial energy requirement for illumination. An induction-based light source does not use electrical connections through a lamp in order to transfer power to the lamp. Electrode-less lamps transfer power by means of electromagnetic fields in order to generate light. In an induction-based light source, an electric frequency generated from an electronic ballast is used to transfer electric power to an induction coil within the lamp. In other embodiments, the electronic ballast transfers electric power to the induction coil, which is externally wrapped around a narrow neck section of the lamp. In accordance with at least some embodiments, light fixture 108 has an increased lifespan with respect to other types, e.g., incandescent and/or fluorescent light sources having electrodes. In accordance with at least some embodiments, light fixture 108 has a reduced initial energy requirement for start up of the light source.

In at least some embodiments, light fixture 108 is electrically connected, either directly or indirectly, to a power source. In at least some alternate embodiments, lighting device 100 comprises more than one light fixture. In at least some embodiments, light fixture 108 is arranged to provide illumination in a directional manner, i.e., downward, upward, etc., with respect to an orientation of the light source. In at least some embodiments, lighting device 100 comprises a plurality of light fixtures arranged at differing elevations and/or at different angular spacing about support pole 106.

In at least some embodiments, induction-based light source 112 comprises a light sensor arranged to trigger activation of the induction-based light source based on a detected light level. In at least some embodiments, the detected light level is determined with respect to a particular or predetermined area proximate support pole 106.

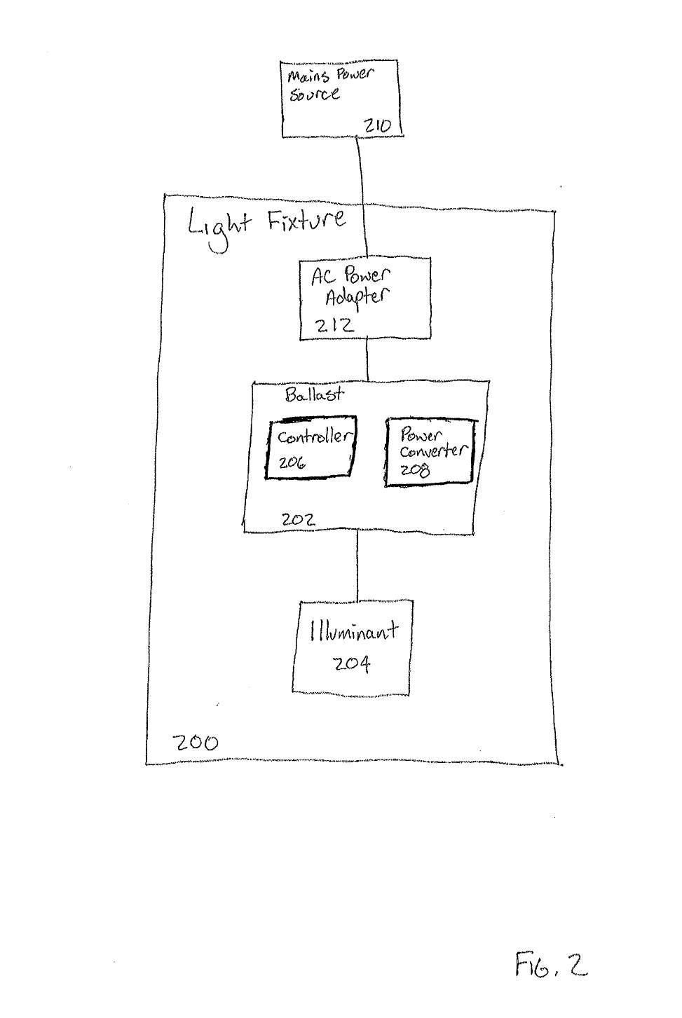

FIG. 2 depicts a high-level functional block diagram of a light fixture 200 connected to a mains power source 210. In at least some embodiments, light fixture 200 is the light fixture used in lighting device 100. Light fixture 200 has an alternating current (AC) power adapter 212, ballast 202 and an illuminant 204. Power adapter 212 electrically connects between the mains power source 210 and the ballast 202. In at least one embodiment, power adapter 212 converts AC power from the main power source 200 to DC power suitable for use by the light fixture 200. In other embodiments, power adapter 212 is optionally included in the light fixture 200, provided that the main power source directs DC power to the light fixture 200. In still other embodiments, power adapter 212 is integrated into ballast 202.

Ballast 202 electrically connects between the power adapter 212 and an illuminant 204. In other embodiments, ballast 202 electrically connects directly between the illuminant 204 and the mains power source 210. Ballast 202 controls the flow of power from the mains power source 210 to the illuminant 204. In at least some embodiments, ballast 202 comprises an electrical connection directly to the mains power source 210. In at least some embodiments, mains power source 210 connection is used as a primary source of power or coupled to other energy sources, such as solar panels, wind turbine, or energy storage device.

Ballast 202 regulates the supply of electricity to the illuminant 204. By regulating the supplied electricity, ballast 202 may prevent and/or minimize unexpected spikes or drops in the supplied electricity level to illuminant 204. In at least some embodiments, ballast 202 may also direct from which component the illuminant 204 receives electricity, e.g., energy storage device or directly from wind turbine, solar panels, etc. In still further embodiments, a light fixture incorporating ballast 202 accounts for lumen loss due to phosphor aging in the lighting layout design.

In an embodiment, ballast 202 comprises a controller 206 and a power converter 208. The power converter 208 converts the power from the mains power source 210 into a frequency suitable to power the illuminant 204. The frequency is typically between 200 kHz to 250 kHz. In other embodiments, the frequency is between 1.0 MHz and 2.0 MHz. The exact frequency and amount of energy generated is controlled by the controller 206. The power supplied is determined by the desired illuminant output which ranges from 10 watts to 500.

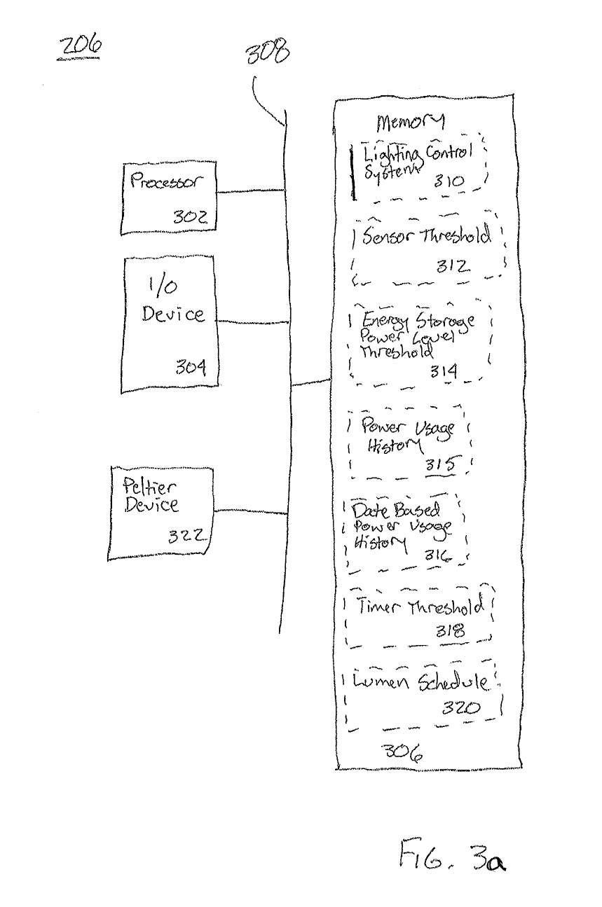

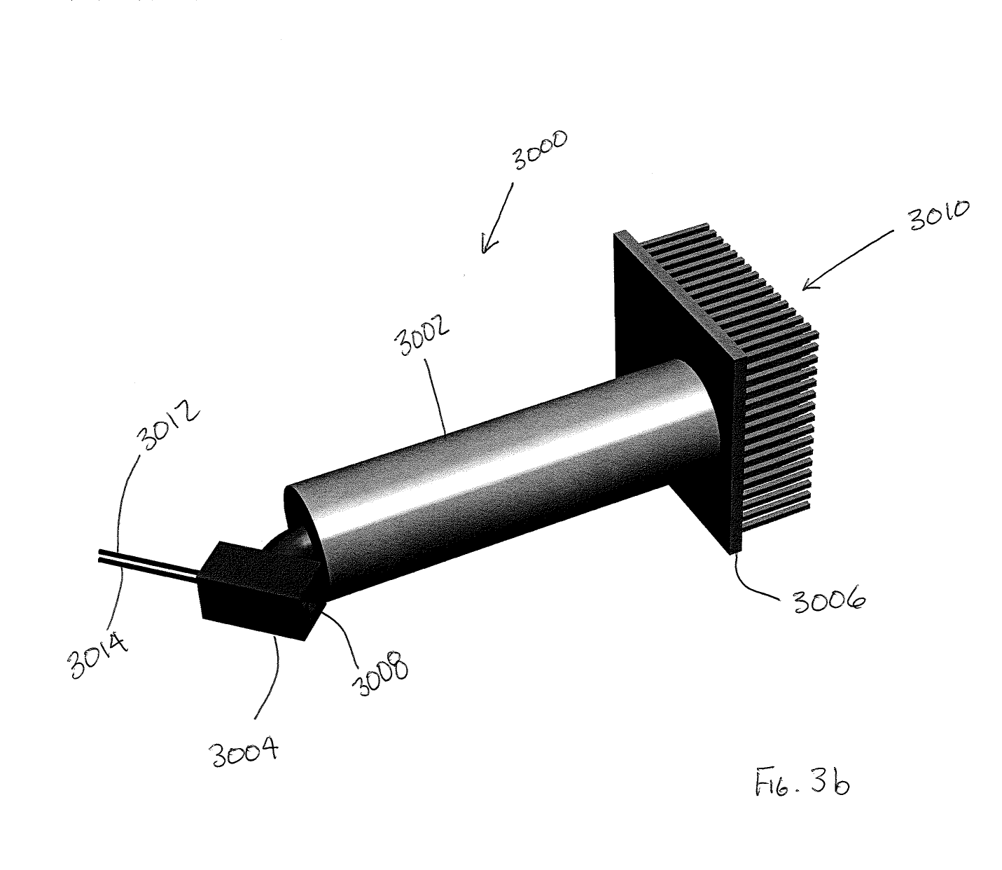

FIG. 3a depicts a high-level functional block diagram of controller 206. In one embodiment, controller 206 is integrated as part of ballast 202. In other embodiments, controller 206 is a stand alone device electrically coupled to the ballast 202.

In at least one embodiment, controller 206 comprises a processor or logic-based device 302, an I/O device 304, a memory 306 each communicatively coupled with a bus 308. In at least some embodiments, processor 302 is a programmable logic device or an application specific integrated circuit. Memory 306 (which may also be referred to as a computer-readable medium) is coupled to bus 308 for storing data and information and instructions to be executed by processor 302. Memory 306 also may be used for storing temporary variables or other intermediate information during execution of instructions by processor 302. Memory 306 may also comprise a read only memory (ROM) or other static storage device coupled to bus 308 for storing static information and instructions for processor 302. Memory 306 may comprise static and/or dynamic devices for storage, e.g., optical, magnetic, and/or electronic media and/or a combination thereof.

Controller 206, executing a set of instructions such as lighting control system 310 stored, e.g., in memory 306, determines whether the power converter 208 should increase or decrease power based on one or more preset conditions stored in memory 306. The preset conditions include one or more of a sensor threshold 312, an energy storage power level threshold 314, a power usage history 315, a date based power usage history 316, a timer threshold 318, or a lumen schedule 320. In some embodiments, the pre-programmed lumen maintenance schedule 320 is stored in memory 306. In response to processor 302 reading the schedule 320 and using one or both of the power usage history 315 or date based power usage history 316 or a timer value (corresponding to an age of the phosphor in illuminant 204) stored in memory 306, the controller 206 signals power converter 208 to increase power to the illuminant 204 to offset declining luminance of the illuminant 204 due to phosphor aging. As a result, lamp output remains uniform over the life of the illuminant 204. In some embodiments, the controller 206 is programmed to compare values, including operating hours and expected lamp lumen depreciation stored in memory 306. The controller 206 uses this information to increase the power output to the lamp over time resulting in a constant lamp lumen.

In at least one embodiment, controller 206 is configured to comprise a single I/O device 304. In other embodiments, controller is configured to comprise more than one I/O device 304.

In some embodiments, I/O Device 304 is integrated into the ballast 202. In other embodiments I/O Device 304 is an external device coupled to the ballast 202, for example a photocell.

I/O device 304 generates a detection signal to processor 302 along bus 308. In at least some embodiments, I/O device 304 detects the presence or absence of light. In at least some other embodiments, I/O device 304 detects an illumination or light level. Processor 302 compares the detection signal produced by I/O device 304 to a sensor threshold value 312 stored in memory 306. Based on the comparison, processor 302 executes lighting control system 310, which is a set of instructions stored in memory 306, to cause the power converter to increase or decrease power supplied to an illuminant based on the result of the comparison. In one embodiment, if a detected light level exceeds the highest threshold value, controller 206 is programmed to turn off or to dim to the lowest level available. For other threshold values, the controller 206 will cause the illuminant 204 to dim to a pre-set value stored in memory 306, such as 10%, 20%, 90% of the maximum lumen output.

In some embodiments, controller 206 contains an I/O device 304, such as a temperature sensor that detects ambient air temperature and ambient temperature of the illuminant 204. In at least some embodiments, controller 206 comprises a temperature sensor and a light sensor.

In some embodiments, illuminant 204 houses amalgam, or an amalgam pellet. The amalgam pellet controls the mercury vapor pressure within the illuminant 204 and is temperature sensitive. In some embodiments, applying heat to the amalgam causes the illuminant 204 to reach full brightness more quickly than without application of heat and maintain full luminance in extreme cold environments. In other embodiments, cooling the amalgam in warm environments improves the mercury vapor pressure within the illuminant 204. In at least some embodiments, cooling the amalgam in warm environments optimizes the mercury vapor pressure. As such, in response to preset conditions stored in memory 306, controller 206 sends signals to the power converter 208 to supply additional heating or cooling as needed to the amalgam pellet that is part of the illuminant 204. In one embodiment, the heating and cooling is performed through the use of a direct-current operated Peltier device 322 or similar. As such, the stability of the lamp lumen output is uniform through a wide range of temperatures, for example −40° F. to 200° F. In at least some embodiments, Peltier device 322 is formed as an integral part of controller 206. In at least some other embodiments, Peltier device 322 is a separate component of illuminant 204 connectable with, and controllable by, controller 206.

In at least one embodiment, a single peltier device/chip is used to both heat and cool the amalgam pellet.

FIG. 3b depicts a side view of a peltier device 3000 incorporated into the lighting device 100 to heat or cool an amalgam pellet. Peltier device 3000 has a thermal transfer rod 3002 between a side 3004 and a side 3006. Side 3004 is configured to contact the amalgam pellet via hole 3008. A heat sink 3010 is also provided along side 3006 to be exposed to ambient air external to the illuminant 204.

Wires 3012 and 3014 are provided to electrically couple the controller 206 to the peltier device 3000.

In an application to cool the amalgam pellet, positive current flow is provided on wire 3012 and negative current flow is provided on wire 3014, which causes side 3004 to be the cold side and side 3006 to be the hot side of the peltier device. In an application to heat the amalgam pellet, negative current flow is provided on wire 3012 and positive current flow is provided on wire 3014, which causes side 3004 to be the hot side and side 3006 to be the cold side of the peltier device.

By reversing the DC current flow through the peltier device 3000, the hot and cold sides of the device are reversed. The polarity of the DC current flowing through the peltier device is controlled by controller (206).

In applications involving extreme cold environments, the heating of the amalgam pellet is performed by a simple direct current resistive heating element wrapped around the amalgam pellet area of the illuminant.

In some embodiments, controller 206 performs self-diagnostics, malfunction or failure notice, end of life forecasting based on usage, excessive temperature detection, excessive lamp current draw detection, current draw vs. hours, and operating temperature vs. hours. Diagnostic error codes and logging will be accessed from the controller 206 through the I/O device 304, such as through direct connection or remotely through an embedded wireless connection.

In some embodiments, I/O device 304 is an embedded wireless transceiver for receiving and sending data to/from the controller 206. Data can be exchanged with a wireless gateway or between similarly equipped light fixtures. Firmware and software updates to the controller 206 can also be performed through the wireless connection.

In some embodiments, ballast 202 is configured for “emergency mode” functionality. Emergency mode could include automatic alerts triggered by calls to emergency services, such as police, fire, health or criminal activity. In some embodiments, emergency mode is manually triggered through use of a switching device communicatively and/or electrically coupled with ballast 202. Upon receiving a wireless signal from an appropriate emergency response system through I/O device 304, the ballast 202 alternates power to the illuminant 204 to blink on/off to assist emergency responders to the approximate location of the call. Additionally, communicatively connected fixtures such as street lights can be made to flash in sequence toward the direction of the emergency location.

In some embodiments, I/O device 304 is an external detection device, such as a video camera or alternatively a radar based detector, to detect occupancy and direction of movement. Based upon the direction of motion, the adjacent fixtures will be contacted through wireless connection and be turned on in advance of their own detection of motion. In at least some embodiments, a wired or powerline data connection is used for communication between fixtures.

In at least some embodiments, I/O device 304 comprises a sensor that generates a motion and/or occupancy detection signal responsive to detection of motion and/or occupancy by living beings within a predetermined area adjacent the illuminant 204. In at least some embodiments, I/O device 304 is a motion sensor positioned to detect movement within the predetermined area. In at least some embodiments, I/O device 304 is an occupancy sensor positioned to detect occupancy by living beings within the predetermined area. In at least some embodiments, I/O device 304 generates radio frequency emissions, e.g., infrared and/or microwave or other emissions, toward the predetermined area and generates the detection signal in response to changes detected in return signals from the predetermined area. I/O device 304 generates the detection signal for use by lighting control system 310 during execution by processor 302.

The controller 206 also comprises memory 306. Memory 306 comprises a lighting control system 310 according to one or more embodiments for determining illumination of the illuminant 208. Lighting control system 310 comprises one or more sets of instructions which, when executed by processor 302, causes the processor to perform particular functionality. In at least some embodiments, lighting control system 310 determines how long the illuminant 204 should be illuminated based on at least signals, e.g., information and/or data, received from I/O device 304 such as an occupancy and/or motion sensor, coupled to the controller.

In at least some further embodiments, lighting control system 310 determines when and/or how long the illuminant 204 should be illuminated based on a monitored power level of an energy storage device, monitored power generating patterns, e.g., with respect to one or both of solar panels and/or wind turbines, and/or a date-based information, or a combination thereof.

In at least one embodiment, lighting control system 310 determines if the illuminant 204 should be illuminated responsive to receipt of a motion/occupancy detection signal from the I/O device 304. Lighting control system 310 determines if the illuminant 204 should be illuminated based on comparing the detection signal value (if applicable) with a sensor threshold value 312 stored in memory 306. If the detection signal value meets or exceeds the sensor threshold value 312, control system 310 causes the power converter 208 to direct power to the illuminant 204, thereby activating the illuminant 204.

In at least some embodiments, sensor threshold value 312 may specify one or more different threshold values. In accordance with such an embodiment, if the detection signal exceeds a lowest threshold value and not a next higher threshold value, the illuminant 204 may be activated at a reduced or dimmed illumination level. If the detection signal exceeds each of the threshold values, the illuminant 204 may be activated at a full illumination level. Dimming of illuminant 204 is accomplished through reduced voltage, current amplitude modulation, change of frequency, or digital pulse-width-modulation burst-dimming to the illuminant 204. The controller 206 is pre-programmed and reads values stored in memory 306 to determine how much to dim the illuminant 204.

In at least some embodiments, lighting control system 310 executes a timer function in conjunction with monitoring for the detection signal in order to dim the illumination level of the illuminant 204, via the power converter 208, during periods of inactivity in the predetermined area adjacent the lighting device. For example, if the timer has exceeded a predetermined inactivity threshold value 318 (stored in memory 306), lighting control system 310 causes power converter 208 to reduce the power directed to the illuminant 208, thereby reducing the illumination level to a dimmed level, e.g., a predetermined percentage of the full output level of the device. In at least some embodiments, lighting control system 310 resets or restarts timer responsive to receipt of a detection signal from I/O device 304.

In at least one embodiment, lighting control system 310 determines how long the illuminant 204 should be illuminated based on comparing an energy potential stored in an energy storage device with an energy storage power level threshold 314 stored in memory 306. In at least some embodiments, energy storage power level threshold 314 comprises a set of values corresponding to different durations in which the illuminant 204 may be illuminated. For example, at a first threshold level, controller 206 may cause the power converter 208 to direct power to the illuminant 204 to illuminate for 4 hours, at a second lower threshold level, the controller may cause the illuminant 204 to illuminate for 2 hours, etc. In at least some embodiments, energy storage power level threshold 314 comprises a single value above which the energy storage power level must exceed in order for controller 206 to cause the light source to illuminate. The energy storage power level threshold 314 may be predetermined and/or user input to controller 206.

In at least one embodiment, lighting control system 310 determines how long the illuminant 204 should be illuminated based on comparing a power usage history 315 stored in memory 306. Power usage history 315 may comprise a single value or a set of values corresponding to a time and/or date based history of the power usage of the illuminant. For example, lighting control system 310 may apply a multi-day moving average to the power usage history of one or both in order to determine the power usage potential for subsequent periods and estimate based thereon the amount of power which may be expended to illuminate the illuminant 204 during the current period. In at least one embodiment, lighting control system 310 applies a three (3) day moving average to the power generating history of one or both of solar panels and wind turbines.

In at least one embodiment, lighting control system 310 determines how long the illuminant 204 should be illuminated based on a date-based power usage estimation 318 stored in memory 306. For example, depending on a geographic installation location of lighting device, controller 206 may determine the illumination of the illuminant 204 based on a projected amount of daylight for the particular location, e.g., longer periods of darkness during winter in Polar locations as opposed to Equatorial locations. In at least some further embodiments, controller 206 may be arranged to cause illumination of the illuminant 204 for a predetermined period of time based on information from one or more of energy storage power level threshold 314, power usage history 315, and/or date-based power usage estimation 316 and after termination of the predetermined period be arranged to cause illumination of the light source responsive to a signal from a motion sensor for a second predetermined period of time.

In at least some further embodiments, lighting control system 310 determines when the illuminant 204 should be illuminated based on receipt of a signal from an occupancy or traffic detector, e.g., a motion sensor operatively coupled with controller 206. In some embodiments, the traffic detector is a radar detector, which is coupled to the controlled and configured to determine traffic rate and direction.

In at least some embodiments, the 10 device 304 is a light sensor to determine if a predetermined threshold has been met in order to transfer electricity to the illuminant 204 to cause the light source to activate and generate illumination. In at least some alternate embodiments, the illuminant 204 comprises the light sensor. The light sensor is a switch controlled by a detected light level, e.g., if the light level is below a predetermined threshold level, the switch is closed and electricity flows to the illuminant 204.

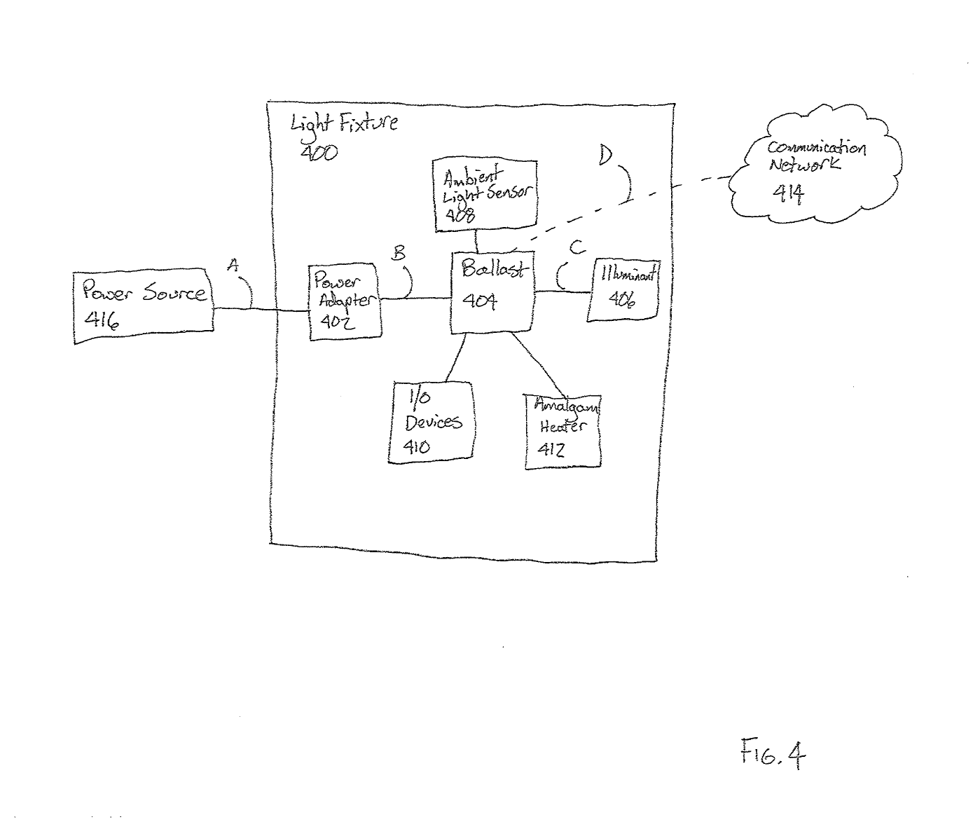

FIG. 4. is a high-level functional block diagram of a lighting fixture 400 connected to a power source 416. In at least some embodiments, power source 416 provides alternating current (AC) via connection A to the power adapter 402 of the light fixture 400. In other embodiments, power source 416 supplies DC voltage. In one embodiment, power adapter 402 rectifies the current to 380 volt direct current (VDC) to the ballast 404 via connection B.

In at least some embodiments, ballast 404 is connected via connection C to an illuminant 406. Ballast 404 contains solid state circuitry that converts the DC current to a very high frequency which is between 200 kHz and 250 kHz, depending on lamp design, and supplies this high voltage, high frequency (HVHF) along connection C to supply power to the illuminant 406. In some embodiments, the solid state circuitry converts the DC current to a frequency between 1.0 MHz to 2.0 MHz.

Ballast 404 is also electrically connected to ambient light sensor 408, 10 devices 410 and amalgam heater 412. In at least one embodiment, ballast 404 is communicatively linked along connection D to a communication network 414.

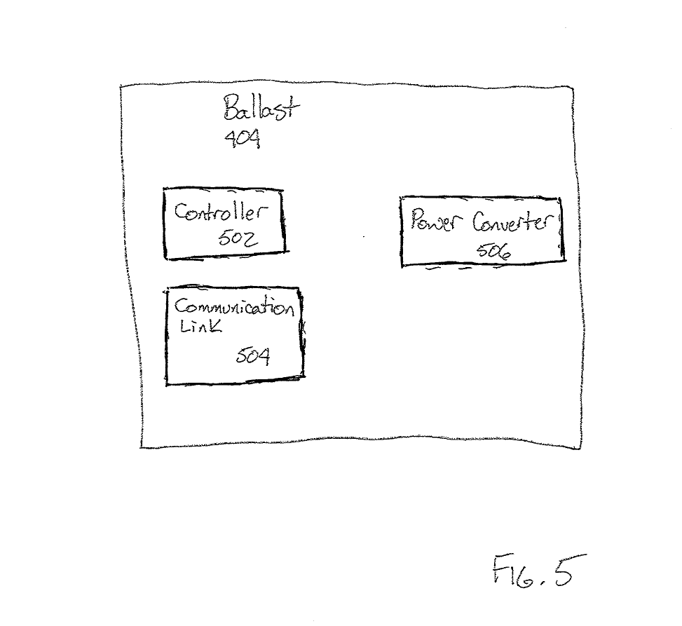

FIG. 5 is a high-level function block diagram of ballast 404. Ballast 404 has a controller 502 connected to a communication link 504. In one embodiment, communication link 504 is a wireless transceiver. In other embodiments, communication link 504 is a wired transceiver. As such, communication link 504 is connected to communication network 414 in one embodiment through a wireless connection. In other embodiments, communication network is connected to communication network 414 via a wired connection.

Controller 502 is also connected to ambient light sensor 408, which, in at least some embodiments, receives ambient light via a light pipe. Controller 502 is also connected to the 10 devices 410, such as a temperature sensor, motion sensor and/or a video camera.

Ballast 404 has a power converter 506 that receives power from the power adapter 402. In response to signals from controller 502, power converter 506 directs power to the I/O devices 410, amalgam heater 412 and illuminant 406.

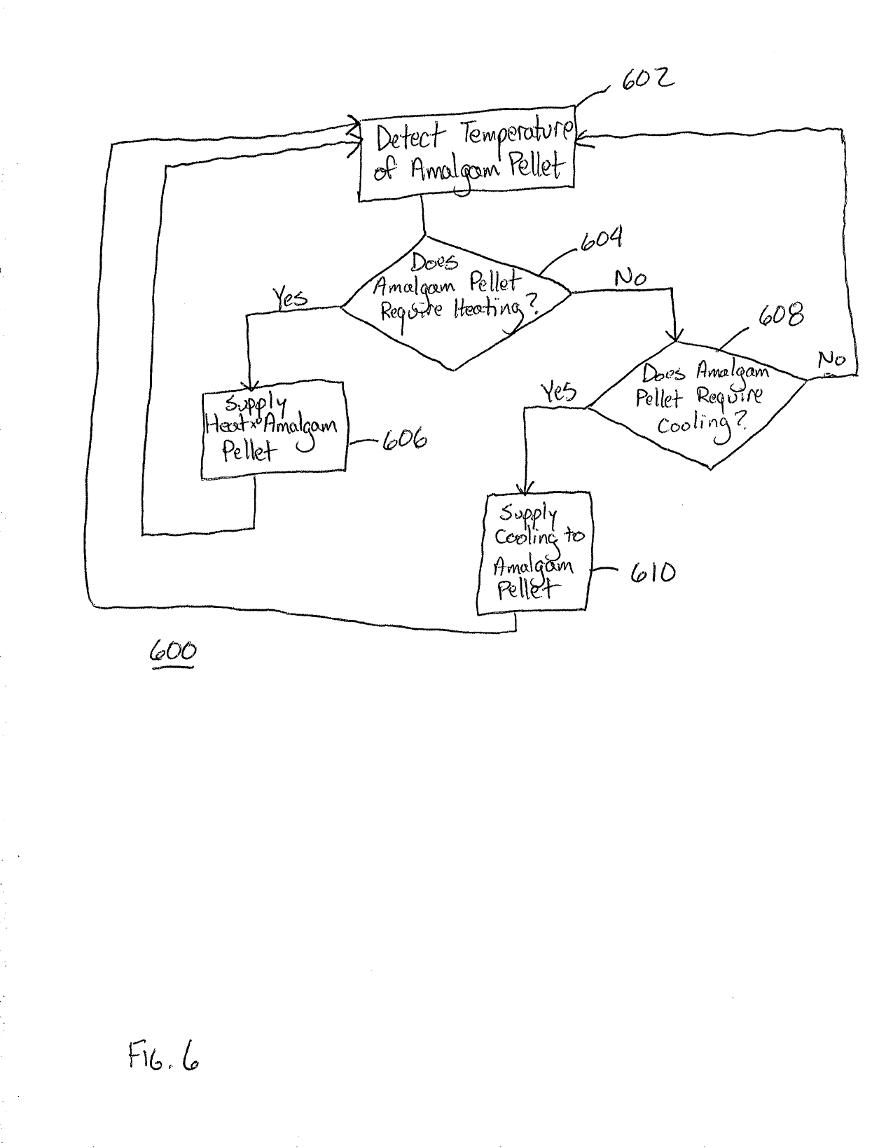

FIG. 6 is a flow chart of at least a portion of a set of instructions such as lighting control system 310 stored in memory 306 which, when executed by processor 302, cause the processor to perform a method 600 of heating and/or cooling an amalgam pellet in accordance with an embodiment. In functional block 602, temperature sensor 302 detects and transmits the temperature of an amalgam pellet contained within illuminant 204 to processor 302. In other embodiments, temperature sensor 302 detects the ambient temperature in and/or around light fixture 108. In functional block 604, processor 302 compares the temperature sensed by temperature sensor 302 to a threshold value 312 in memory 306. If the temperature exceeds the threshold value 312, in functional block 606, processor 302 sends a signal to cause Peltier device 322 to heat the amalgam pellet. In functional block 608, processor 302 compares the temperature sensed by temperature sensor 302 to a threshold value 312 in memory 306 to determine if the temperature is below the threshold value 312. If the temperature is below the threshold value 312, in functional block 610, processor 302 sends a signal to cause Peltier device 322 to cool the amalgam pellet. In at least some embodiments, the method 600 is modified to solely heat or solely cool the amalgam depending on comparison with a threshold value.

In another embodiment, luminous flux sensor 302 detects the amount of flux generated by the illuminant 204. In functional block 604, processor 302 compares the flux sensed by luminous flux sensor 302 to a threshold value 312 in memory 306. If the luminous flux sensor exceeds the threshold value 312, in functional block 606, processor 302 sends a signal to cause Peltier device 322 to heat the amalgam pellet. In functional block 608, processor 302 compares the luminous flux sensed by luminous flux sensor 302 to a threshold value 312 in memory 306 to determine if the flux is below the threshold value 312. If the flux is below the threshold value 312, in functional block 610, processor 302 sends a signal to cause Peltier device 322 to cool the amalgam pellet. In at least some embodiments, the method 600 is modified to solely heat or solely cool the amalgam depending on comparison with a threshold value.

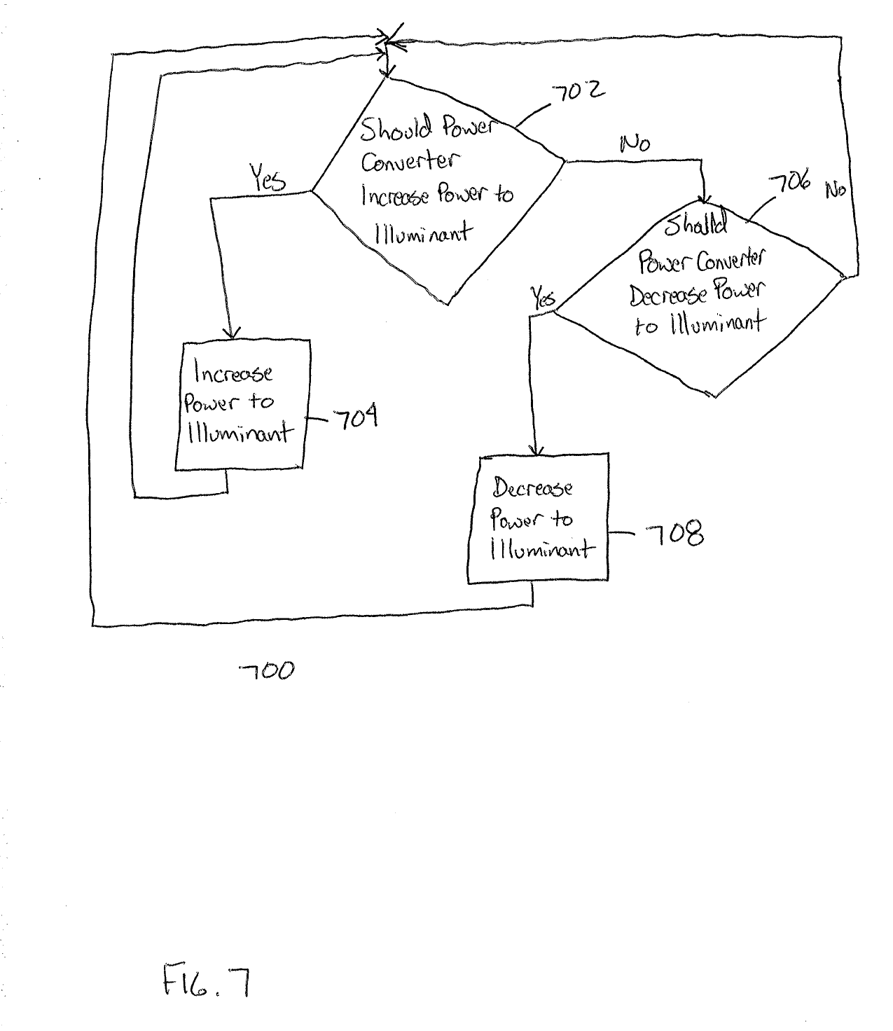

FIG. 7 is a flow chart of at least a portion of a set of instructions such as lighting control system 310 stored in memory 306 which, when executed by processor 302, cause the processor to perform a method 700 of increasing or decreasing power to the illuminant in accordance with an embodiment. In functional block 702, processor 302 determines whether the power converter should increase power to the illuminant 204 based on preset conditions stored in memory 306. If the processor 302 determines that power to the illuminant 204 should be increased based on preset conditions stored in memory 306, then, in functional block 704, the processor 302 signals the power converter 208 to increase the power supplied to the illuminant 204. In this regard, processor 302 executes the instructions stored in memory 306 to increase power to the illuminant 204 to offset declining luminance of the illuminant 204 due to phosphor aging. As a result, lamp output remains uniform over the life of the illuminant 204.

In functional block 706, processor 302 determines whether the power converter should decrease power to the illuminant 204 based on preset conditions stored in memory 306. If the processor 302 determines that power to the illuminant 204 should be decreased based on preset conditions stored in memory 306, then, in function block 708, the controller 206 signals the power converter 208 to decrease the power supplied to the illuminant 708. Power supply is decreased by altering voltage, current modulation, frequency or through the use of digital pulse-width-modulation burst-dimming. As such, the life span of the illuminant 204 is increased. In at least some embodiments, the method 700 is modified to solely increase or solely decrease the power to the illuminant based on the preset conditions stored in memory 306.

In some embodiments, controller 206 is configured to comprise at least one I/O device 304. In this embodiment, in function block 702, processor 302 compares the detection signal produced by I/O device 304 to a sensor threshold value 312 stored in memory 306 to determine whether the power converter should increase power to the illuminant 204. If so, then, in functional block 704, processor 302 executes lighting control system 310, which is a set of instructions stored in memory 306 to increase power to the illuminant 204. In functional block 706, processor 302 compares the detection signal produced by I/O device 304 to a sensor threshold value 312 stored in memory 306 to determine whether the power converter should decrease power to the illuminant 204. If so, then, in functional block 708, processor 302 executes lighting control system 310, which is a set of instructions stored in memory 306 to decrease power to the illuminant 204.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A ballast system to regulate the supply of power to an illuminant, comprising:
a controller coupled to a power converter, the controller comprising a processor and a memory communicatively coupled with a bus,
the memory comprising a lighting control system, the processor being configured to execute the lighting control system to cause the power converter to increase or decrease power supplied to an illuminant.

2. The ballast system of claim 1, wherein the controller further comprises an I/O device, the I/O device being configured to produce a detection signal, the processor being configured to execute the lighting control system to compare the detection signal to a threshold value stored in the memory, wherein the processor being further configured to cause the power converter to increase or decrease power supplied to an illuminant based on the result of the comparison of the detection signal to the sensor threshold value.

3. The ballast system of claim 1, wherein the illuminant is an induction based light source.

4. The ballast system of claim 1, further comprising a communication link configured to connect to a communication network to transmit and receive data from the controller.

5. The ballast system of claim 2, wherein the I/O device comprises at least one of a light sensor, a temperature sensor, a video camera, an occupancy sensor, a motion detector, a radar detector or a traffic detector.

6. The ballast system of claim 1, further comprising a thermoelectric device connected to the controller for providing heating or cooling to the illuminant.

7. The ballast system of claim 1, wherein the memory comprises at least one of a lumen schedule, timer threshold, date based power usage history, power usage history, energy storage power level threshold, sensor threshold, operating temperature, maximum or minimum operating temperatures, current draw, occupancy, direction of motion, time, illumination duration, or age of illuminant.

8. The ballast system according to claim 2, wherein the threshold value comprises at least one of a lumen schedule, timer threshold, date based power usage history, power usage history, energy storage power level threshold, sensor threshold, operating temperature, maximum or minimum operating temperatures, current draw, occupancy, direction of motion, time, illumination duration, or age of illuminant.

9. The ballast system of claim 1 communicatively linked to at least one other ballast system according to claim 1, the communicatively linked ballast systems arranged to generate an emergency response signal.

10. A ballast system to account for operating conditions of an illuminant, comprising:
a means for controlling the supply of power to an illuminant;
a means for producing a detection signal;
a means for comparing the detection signal to a threshold value; and
a means for determining whether to increase or decrease power supplied from a power converter to an illuminant based on the comparison of the detection signal to the threshold value.

11. The ballast system of claim 10, wherein the threshold value stored in the memory comprises at least one of a lumen schedule, timer threshold, date based power usage history, power usage history, energy storage power level threshold, sensor threshold, operating temperature, maximum and minimum operating temperatures, current draw, occupancy, direction of motion, time, illumination duration, or age of illuminant.

12. The ballast system of claim 10, further comprising a means for communicating with a communication network.

13. The ballast system of claim 10, wherein the illuminant is an induction based light source.

14. The ballast system of claim 10, further comprising a means for providing heating or cooling an amalgam pellet contained within the illuminant.

15. The ballast system of claim 10, further comprising a means for communicatively linking to at least one other ballast system according to claim 8, the communicatively linked ballast systems configured to generate an emergency response signal.

16. A method for increasing or decreasing luminescence of a lamp, comprising:
detecting a signal at a ballast comprising a controller coupled to a power converter;
comparing the signal to a threshold value stored in the controller; and
signaling the power converter to increase or decrease power supplied from the power converter to an illuminant based on the comparison of the signal to the threshold value.

17. The method of claim 16, further comprising communicating with a communication network to send and receive data from the controller.

18. The method of claim 16, wherein the threshold value stored in the memory comprises at least one of a lumen schedule, timer threshold, date based power usage history, power usage history, energy storage power level threshold, sensor threshold, operating temperature, maximum and minimum operating temperatures, current draw, occupancy, direction of motion, time, illumination duration, or age of illuminant.

19. The method of claim 16, further comprising providing heating or cooling an amalgam pellet contained within the illuminant.

20. The ballast system of claim 16 communicating with another ballast system to generate an emergency response signal.
